(19) United States
(12) Patent Application Publication
(10) Pub. No.: US 2024/0317415 A1
(43) Pub. Date: Sep. 26, 2024

(54) PROPULSION UNIT COMPRISING PENDULAR BIFURCATION PANELS

(71) Applicant: SAFRAN NACELLES, Gonfreville-L'Orcher (FR)

(72) Inventors: Patrick André BOILEAU, Moissy-Cramayel (FR); Gérard CLERE, Moissy-Cramayel (FR); Jean-Philippe JORET, Moissy-Cramayel (FR)

(21) Appl. No.: 18/574,120

(22) PCT Filed: Jun. 27, 2022
(86) PCT No.: PCT/FR2022/051270

§ 371 Date: Dec. 26, 2023

(30) Foreign Application Priority Data
Jun. 28, 2021 (FR) FR2106884

(51) Int. Cl. B64D 29/06; F02K 1/32

(52) U.S. Cl. CPC B64D 29/06; F02K 1/32

(57) ABSTRACT

A propulsion unit includes a fairing delimiting a flow conduit for a secondary flow. This fairing comprises includes panels, at least one of which is articulated on a mast via connecting members such as clevises.

### TECHNICAL FIELD

The invention relates to the field of propulsion units for aircraft.

### PRIOR ART

Conventionally, a turbine engine of a propulsion unit is connected to an aircraft wing by means of a mast.

During the various flight phases, the propulsion unit is subjected to aerodynamic loads that cause relative movements of the turbine engine with respect to the mast and corresponding deformations of a fairing of the propulsion unit.

### DESCRIPTION OF THE INVENTION

One aim of the invention is to procure a propulsion unit making it possible to reduce the deformation stresses of the fairing resulting from movements of the turbine engine with respect to the mast.

Another aim of the invention is to propose an architecture compatible with the use of a thrust reverser with movable cascades.

Another aim of the invention is to facilitate maintenance operations on the propulsion unit.

For this purpose, the object of the invention is a propulsion unit for an aircraft, comprising a mast, an internal fairing, an external fairing and a lateral fairing, the internal fairing delimiting radially inwards a flow conduit of a secondary flow, the external fairing delimiting the conduit radially outwards, the lateral fairing extending on either side of the mast so as to delimit two circumferential ends of the conduit. According to the invention, the lateral fairing comprises one or more panels connected to the mast in a connection defining at least one degree of freedom.

The invention thus makes it possible to reduce the deformation stresses on these panels and more generally on the fairing of the propulsion unit.

The aforementioned at least one degree of freedom may be a degree of freedom in translation and/or in rotation.

In particular, said connection may be a pivot, slide or sliding pivot connection.

The connection may be formed by one or more connecting members.

Such connecting members may be connected to a radially external end of one or more of said panels.

It is preferred for the panels to be disposed symmetrically on either side of the mast, on the understanding that several of the panels may be disposed on the same side of the mast.

The lateral fairing may comprise both one or more of said panels as described above, i.e. connected to the mast in a connection defining at least one degree of freedom (first type of panel), and one or more other panels connected to other parts of the propulsion unit (second type of panel).

In one embodiment, the lateral fairing comprises at least two panels, at least one of which is of the first type, extending on a first side of the mast, and at least two other panels, at least one of which is of the first type, extending on a second side of the mast. The presence of a plurality of panels on each side of the mast makes it possible to selectively access spaces faired by these panels in the context of maintenance operations. In addition, such panels make it possible to access such spaces without removing other parts of the propulsion unit.

Hereinafter, when reference is made to one or more panels, these relate by default to the panels of the first type. However, the following description can apply by analogy to the panels of the second type.

In one embodiment, the propulsion unit comprises one or more linkages and/or cross members extending transversely so as to connect one or more of said panels extending on a first side of the mast to one or more others of said panels extending on a second side of the mast.

Each end formed by such linkages or cross members can in particular be connected to a radially internal end of a respective one of the panels.

The propulsion unit may be devoid of any rigid connection between one or more of said panels and the internal fairing.

In one embodiment, one or more of said panels are configured to crush a sealing member such as a gasket interposed between this or these panels and the internal fairing.

In one embodiment, the propulsion unit comprises a thrust reverser.

Preferably, the reverser comprises a structure able to move between an advanced position, making it possible to direct the secondary flow towards the rear of the propulsion unit in order to generate a thrust, and a retracted position, making it possible to redirect a part of the secondary flow towards the front of the propulsion unit in order to generate a counter-thrust.

In one embodiment, the propulsion unit comprises a support structure connected to the mast and being intended to be connected to a turbine engine of the propulsion unit so as to be able to follow the movements of the turbine engine with respect to the mast.

Preferably, the movable structure of the reverser is supported by the support structure.

The reverser can thus be mounted floating with respect to the mast.

In one embodiment, the support structure forms a cradle including two longitudinal members extending respectively on either side of the mast.

The support structure can thus comprise connecting elements such as crossmembers or linkages extending transversely so as to connect the longitudinal members to each other.

One or more of said panels can be attached to the support structure, for example on one or other of the aforementioned longitudinal members.

Preferably, the longitudinal members of the cradle form means for guiding the movable structure of the reverser.

In one embodiment, the movable structure of the reverser comprises diversion cascades.

In one embodiment, the external fairing forms one or more cowls of the movable structure of the reverser.

Naturally the invention also covers a propulsion unit as described above and comprising a turbine engine.

In one embodiment, the turbine engine is a turbojet engine, for example of the bypass type.

Another object of the invention is an aircraft equipped with such a propulsion unit.

According to another aspect, an object of the invention is a method for mounting/removing one or more of said panels of such a propulsion unit, for example in the context of a maintenance operation.

Other advantages and features of the invention will appear upon reading the detailed, non-limiting description that follows.

### BRIEF DESCRIPTION OF THE DRAWINGS

The following detailed description refers to the accompanying drawings in which:

FIG. 1 is a schematic longitudinal sectional view of a propulsion unit according to the invention, comprising a reverser in the direct-thrust configuration;

FIG. 2 is a schematic view in longitudinal section of the propulsion unit of FIG. 1, the reverser being in the thrust-reversal configuration;

FIG. 3 is a schematic perspective view of the propulsion unit of FIG. 1, showing an internal fairing, an external fairing and bifurcation panels delimiting a secondary flow path;

FIG. 4 is a schematic perspective half-view of the propulsion unit of FIG. 1, the external fairing being in an open maintenance position;

FIG. 5 is a schematic view of the propulsion unit of FIG. 1, showing the internal fairing, the bifurcation panels and a cradle suspending a movable structure of the reverser;

FIG. 6 is a schematic perspective view of the propulsion unit of FIG. 1, showing a part of the bifurcation panels, linkages connecting these panels and a fixed structure of the propulsion unit;

FIG. 7 is a schematic view in cross section of the propulsion unit of FIG. 1, along a first cutting plane passing through a means for connecting a first of said panels with a beam of the cradle;

FIG. 8 is a schematic view in cross section of the propulsion unit of FIG. 1, along a second cutting plane passing through a means for connecting a second of said panels with a beam of the cradle;

FIG. 9 is a schematic view in cross section of the propulsion unit of FIG. 1, along a third cutting plane passing through a first member for connecting said second panel with the mast;

FIG. 10 is a schematic view in cross section of the propulsion unit of FIG. 1, along a fourth cutting plane passing through a second member for connecting said second panel with the mast.

### DETAILED DESCRIPTION OF EMBODIMENTS

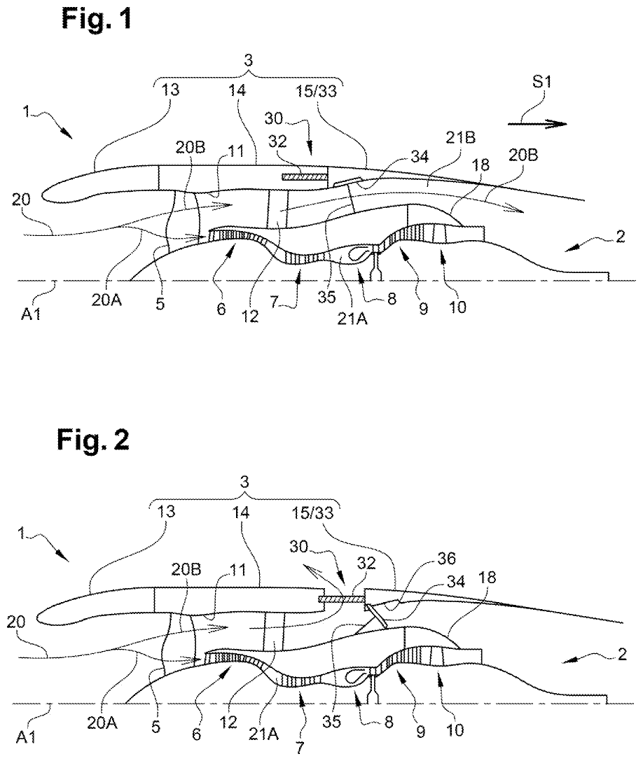

FIGS. 1 and 2 show a propulsion unit 1 of an aircraft having a longitudinal central axis A1.

Hereinafter, the terms “front” and “rear” are defined with respect to a main direction S1 of gas flow through the propulsion unit 1 along the axis A1 when it generates a thrust.

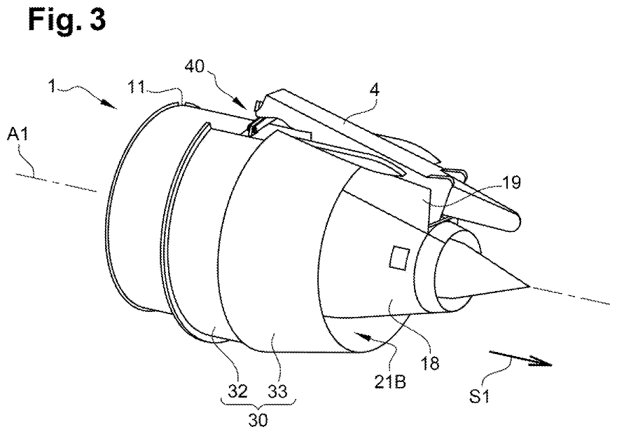

The propulsion unit 1 comprises a turbine engine 2, a nacelle 3 and a mast 4 (visible in FIG. 3) intended to connect the propulsion unit 1 to a wing (not shown) of the aircraft.

The turbine engine 2 is a bypass turbojet engine comprising, from front to rear, a fan 5, a low-pressure compressor 6, a high-pressure compressor 7, a combustion chamber 8, a high-pressure turbine 9 and a low-pressure turbine 10. The compressors 6 and 7, the combustion chamber 8 and the turbines 9 and 10 form a gas generator. The turbojet engine 2 is provided with a fan casing 11 connected to a hub of the turbojet engine 2 by radial arms 12.

The nacelle 3 comprises a front section forming an air inlet 13, a middle section which includes fan cowls 14 covering the fan casing 11 and a rear section 15.

With reference to FIGS. 1 and 3, the nacelle 3 comprises an internal fairing 18 that encloses the gas generator, an external fairing 33 of the rear section 15 and a lateral fairing 19 that comprises one part extending on one side of the mast 4 and another part extending on the other side of the mast 4. Each of these parts of the lateral fairing 19 extends radially between the internal fairing 18 and the external fairing 33 so as to form a bifurcation or connecting island (see FIG. 3).

These various fairing elements 18, 19 and 33 delimit a conduit having a semi-annular cross-section and forming a secondary flow path 21B of the propulsion unit 1.

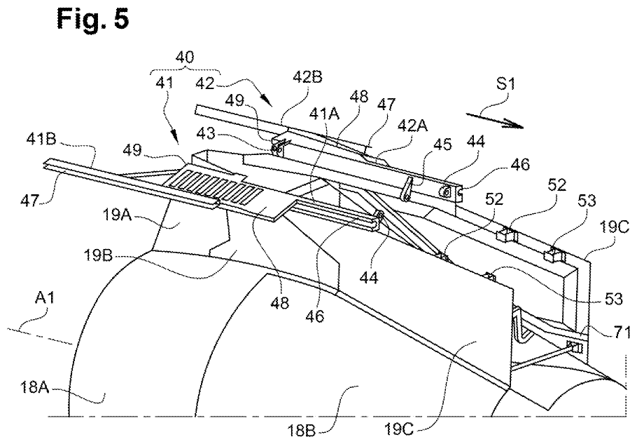

More precisely, the secondary flow path 21B is delimited radially inwards by the internal fairing 18. In the example in FIG. 5, the latter comprises a first semicircular portion 18A passing through the middle section and a second semicircular portion 18B extending the first portion 18A towards the rear in the rear section of the nacelle 3.

Radially towards the outside, the secondary flow path 21B is delimited firstly at the middle section by the fan casing 11 and secondly at the rear section 15 by the external fairing 33.

The lateral fairing 19 delimits two circumferential ends of the secondary flow path 21B, which extends in this example circumferentially around the axis A1 continuously from one to the other of these ends (see FIG. 3).

In operation, an air flow 20 enters the propulsion unit 1 through the air inlet 13, passes through the fan 5 and then splits into a primary flow 20A and a secondary flow 20B (see FIG. 1). The primary flow 20A flows in a primary gas flow path 21A passing through the gas generator. The secondary flow 20B flows in the secondary flow path 21B described above.

The nacelle 3 comprises a thrust reverser 30 forming a structure able to move with respect to the turbojet engine 2.

In this example, the movable structure of the reverser 30 comprises diversion cascades 32, the aforementioned external fairing 33, closure flaps 34 and linkages 35.

FIG. 1 shows the reverser 30 in a direct-thrust configuration. In this configuration, the cascades 32 and the external fairing 33 are in an advanced position, in which the external fairing 33 is substantially in abutment on a rear end of the middle section and in which the cascades 32 are housed in a space delimited radially by the fan casing 11 on the one hand and by the fan cowls 14 on the other hand. In direct-thrust configuration, the flaps 34 are retracted in a cavity 36 (see FIG. 2) formed by the external fairing 33. The reverser 30 can thus channel the secondary flow 20B towards the rear of the propulsion unit 1 so as to generate a thrust.

FIG. 2 shows the reverser 30 in a thrust-reversal configuration. In this configuration, the cascades 32 and the external fairing 33 are in a retracted position, in which the external fairing 33 is longitudinally distant from the middle section so as to define a radial opening of the secondary flow path 21B and in which the cascades 32 extend through this radial opening. In thrust-reversal configuration, the flaps 34 are deployed radially in the secondary flow path 21B so as to direct the secondary flow 20B towards the cascades 32, which orient the flow thus redirected towards the front of the propulsion unit 1 in order to generate a counter-thrust.

The reverser 30 has in this example a C-shaped architecture, known per se, in which the external fairing 33 forms two cowls 33 symmetrical with respect to an imaginary longitudinal midplane passing through the axis A1 and passing through the mast 4. A first circumferential end of each of the cowls 33 extends at twelve o'clock facing a respective panel of the mast 4 (see further below). In flight situation, the cowls 33 are connected to each other by their second circumferential end that extends at six o'clock, i.e. opposite to the mast 4.

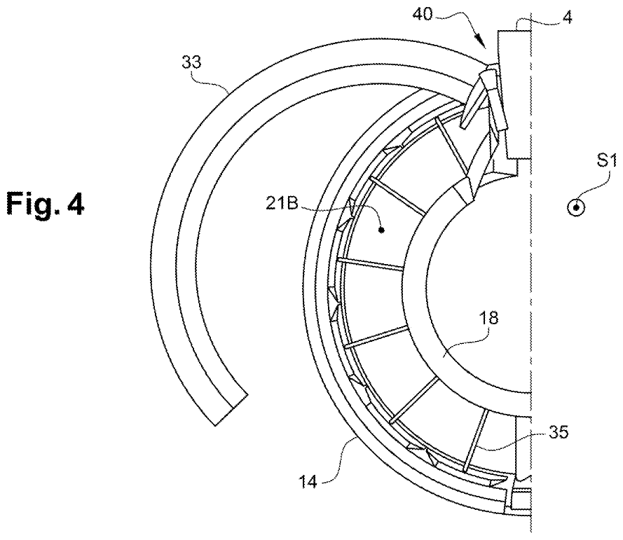

With reference to FIG. 4, which shows half of the propulsion unit 1 located on one side of the aforementioned longitudinal midplane, such an architecture makes it possible to place the cowls 33 in a maintenance position, by pivoting them by their first end about a pivot axis (not shown) parallel to the axis A1 or slightly oblique with respect to the axis A1.

In a variant embodiment, not shown, the reverser 30 has an O-shaped architecture, also known per se, in which the external fairing 33 forms a single-piece semi-annular cowl having two circumferential ends each extending facing a respective panel of the mast 4.

In this example, the propulsion unit 1 comprises an intermediate support structure 40 to which the cascades 32 and the cowls 33 of the reverser 30 are connected.

With reference to FIG. 5, the support structure 40 forms overall a cradle extending at twelve o'clock, i.e. at the mast 4, and comprises a front part connected to the turbojet engine 2 and a rear part connected to the mast 4 as described below.

The cradle 40 comprises in this example two longitudinal members 41 and 42 that extend along the axis A1 and are symmetrical with respect to the aforementioned longitudinal midplane.

With reference to the longitudinal member 42 of FIG. 5, this forms a primary beam 42A extending axially so as to form a front end and a rear end.

The primary beam 42A comprises three connecting members 43, 44 and 45 of the clevis type that each extend circumferentially in line with an internal surface formed by this primary beam 42A, in the direction of the longitudinal member 41.

Axially, the first connecting member 43 extends at the front end of the primary beam 42A, the second connecting member 44 extends at the rear end of this beam 42A and the third connecting member 45 extends between these front and rear ends, in proximity to the second connecting member 44 on a rear part of the cradle 40.

Each of these connecting members 43, 44 and 45 forms an orifice that passes through them axially.

Circumferentially opposite said internal surface of the primary beam 42A, the latter comprises a first rail 46 that extends axially from the front end as far as a rear end of the primary beam 42A.

The longitudinal members 41 and 42 being symmetrical, the longitudinal member 41 also comprises a primary beam 41A, the above description applying by analogy to the longitudinal member 41.

With reference to the longitudinal member 41 of FIG. 5, this comprises a secondary beam 41B circumferentially offset towards the outside and axially offset towards the front with respect to the primary beam 41A.

The secondary beam 41B forms a second rail 47 extending axially from a front end to a rear end of this secondary beam 41B, parallel to the first rail formed by the primary beam 41A.

The longitudinal member 41 comprises a structural piece 48 connecting the primary beam 41A and secondary beam 41B to each other.

In this example, the structural piece 48 forms flow-diversion fins. In variants that are not shown, the structural piece 48 can be solid or form openings with no fins.

Naturally, the longitudinal member 42 also comprises a secondary beam 42B and a structural piece 48, the above description applying by analogy to the longitudinal member 42.

The cradle 40 also comprises two fourth connecting members 49 each extending axially towards the front in line with the front end of a respective one of the primary beams 41A and 42A and each forming an orifice that passes through them transversely, i.e. in a direction passing through a plane orthogonal to the axis A1.

The cradle 40 in this example comprises two linkages (not shown) extending transversely so as to connect the longitudinal members 41 and 42 to each other.

A first of these linkages is articulated by one of its ends on the first connecting member of the longitudinal member 41 by means of a shaft (not shown) passing through the orifice formed by this connecting member and by its other end on the first connecting member 43 of the longitudinal member 42 also by means of a shaft (not shown) passing through the orifice formed by this connecting member 43.

Similarly, the second of these linkages is articulated by one of its ends on the second connecting member 44 of the longitudinal member 41 by means of a shaft (not shown) passing through the orifice formed by this connecting member 44 and by its other end on the second connecting member 44 of the longitudinal member 42 also by means of a shaft (not shown) passing through the orifice formed by this connecting member 44.

In a variant, the longitudinal members 41 and 42 of the cradle 40 can be connected to each other by other types of connecting element, for example by crossmembers secured rigidly to the longitudinal members 41 and 42.

The cradle 40 is disposed at the mast 4 so that the longitudinal members 41 and 42 extend on either side of the mast 4, and is secured to the latter by third connecting members 45.

In this example, the mast 4 comprises two complementary connecting members (not shown) that each extend in line with a respective panel of the mast 4 each in the direction of a respective one of the longitudinal members 41 and 42.

The third connecting member of the longitudinal member 41 is connected to one of these complementary connecting members via a shaft (not shown) passing through the orifice formed by this third connecting member. Symmetrically, the third connecting member 45 of the longitudinal member 42 is connected to the other complementary connecting member of the mast 4 via a shaft (not shown) passing through the orifice formed by this third connecting member 45.

A rear part of the cradle 40 is thus connected to the mast 4 in pivot connections allowing a relative movement of each of the longitudinal members 41 and 42 with respect to the mast 4 rotating about an axis defined by a respective one of the aforementioned connecting shafts.

The cradle 40 is moreover connected to the turbine engine 2 by fourth connecting members 49. For this purpose, the turbojet engine 2 comprises in this example two complementary connecting members (not shown) that each extend radially outwards in line with the fan casing 11.

The fourth connecting member 49 of the longitudinal member 41 is connected to one of these complementary connecting members via a transverse shaft (not shown) passing through the orifice formed by this connecting member 49. Symmetrically, the fourth connecting member 49 of the longitudinal member 42 is connected to the other complementary connecting member of the turbojet engine 2 via a transverse shaft (not shown) passing through the orifice formed by this connecting member 49.

A rear part of the cradle 40 is thus connected to the turbojet engine 2 in pivot connections allowing a relative movement of each of the longitudinal members 41 and 42 with respect to the mast 4 rotating about an axis defined by a respective one of the aforementioned connecting shafts.

The various aforementioned connecting shafts are preferably removable in order to allow rapid and simplified dismantling of the cradle 40 and/or of the turbojet engine 2.

In this example, the turbojet engine 2 is moreover connected to the mast 4 by a front suspension (not shown) secured to the fan casing 11 and extending in the vicinity and in front of the four connecting members 49 of the cradle 40 and by a rear suspension (not shown) extending in the vicinity and in front of the third connecting members 45 of the cradle 40.

The cradle 40 supports the cascades 32 and the cowls 33.

In particular, each of the cowls 33 of the reverser 30 cooperates by its circumferential front end with the rail 46 of the respective one of the primary beams 41A and 42A of the cradle 40, the rails 46 thus forming the means for guiding the cowls 33 between the advanced and retracted positions.

In a similar manner, the cascades 32 of the reverser 30 are connected to the secondary beams 41B and 42B of the cradle 40 so that the rails 47 form means for guiding the cascades 32 between the advanced and retracted positions.

The movable structure of the reverser 30 is thus mounted floating on the mast 4, by means of the cradle 40, which enables the cascades 32 and the cowls 33 to follow the movements of the turbojet engine 2 with respect to the mast 4.

In this example, when the cascades 32 are in the retracted position, they are axially aligned with the fins formed by the structural pieces 48 of the cradle 40. These fins thus increase the useful surface for diverting the secondary flow 20B in thrust reversal.

The invention relates more specifically to mounting the lateral fairing 19, having regard to the relative movements of the turbojet engine 2 and of the nacelle 3 with respect to the mast 4.

With reference to FIG. 5, the lateral fairing 19 comprises a first part extending on the same side of the mast 4 as the longitudinal member 41 of the cradle 40 and a second part extending on the same side of the mast 4 as the longitudinal member 42 of the cradle 40.

The lateral fairing 19 being symmetrical with respect to the aforementioned longitudinal midplane, the following description relating to the first part of the lateral fairing 19 applies by analogy to the second part of this lateral fairing 19.

In this example, the first part of the lateral fairing 19 comprises three panels 19A, 19B and 19C, also referred to as bifurcation panels, which extend respectively from front to rear.

Each of the panels 19A, 19B and 19C has an internal end and an external end defining their radial dimension, as well as a front end and a rear end defining their axial dimension.

The internal end of the panels 19A, 19B and 19C has a curved geometry enabling them to follow the contour of the internal fairing 18 along the axis A1 so as to provide aerodynamic continuity for the secondary flow 20B.

In this example, the internal end of the panel 19A extends axially between a front end of the portion 18A of the internal fairing 18 and an intermediate part of this portion 18A, the internal end of the panel 19B extends axially between this intermediate part of the portion 18A and an intermediate part of the portion 18B of the internal fairing 18, and the internal end of the panel 19C extends axially between this intermediate part of the portion 18B and a rear end of this portion 18B.

The external end of the panels 19A, 19B and 19C has in this example rectilinear segments and its geometry is configured so that the panels 19A, 19B and 19C extend roughly radially under the rails 46 and 47 of the cradle 40.

In this example, the external end of the panels 19A and 19B as well as a front part of the panel 19C runs along the primary beam 41A from its front end to its rear end. The external end of the rear part of the panel 19C is extended axially at the rear of the primary beam 41A.

With regard to the geometry of the front and rear ends of the panels 19A, 19B and 19C, the front end of the panel 19A and the rear end of the panel 19C are here substantially rectilinear.

The front and rear ends of the panel 19B have a more complex geometry formed by a plurality of rectilinear segments that is determined according to the access requirements for maintenance and to the configuration of the mast 4 and of the members of the propulsion unit 1 disposed in the mast 4 and/or at the rear of these panels.

The geometry of the rear end of the panel 19A and the front end of the panel 19C is complementary to that of the front and rear ends of the panel 19B, respectively, so as to provide aerodynamic continuity for the secondary flow 20B.

Naturally, the particular geometry of the panels 19A, 19B and 19C and the number thereof are here given by way of in no way limitative example and can be modified in particular according to the relative dimensions of the various parts of the propulsion unit 1 and the arrangement of the equipment or members liable to need maintenance operations.

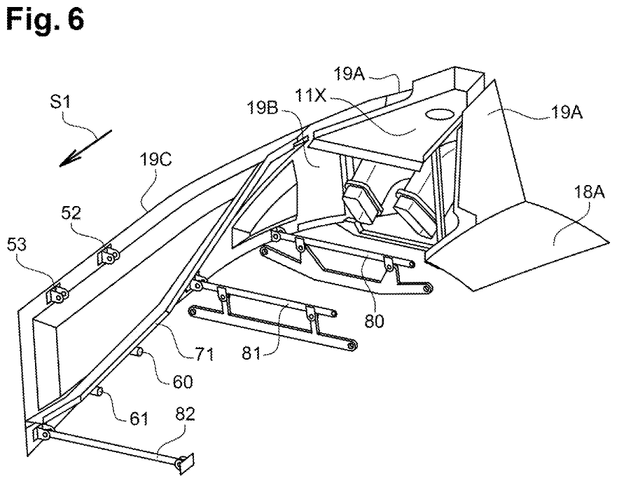

In this example, the panel 19A is secured in a conventional manner to a fixed structure 11X secured to the turbojet engine 2 (see FIG. 6), using securing means (not shown) such as bolts, screws or rivets. The internal end of the panel 19A is in this example welded or produced in a single piece with the portion 18A of the internal fairing 18.

With regard to the panel 19B, its front end forms a lip coming into abutment on an internal surface of the panel 19A so as to form a continuous smooth join. The panels 19A and 19B are secured to each other by securing means such as bolts, screws or rivets distributed along this lip.

In a variant embodiment that is not shown, the front end of the panel 19B is secured to the fixed structure 11X by means of such securing means.

The external end of the panel 19B is secured to a front part of the primary beam 41A of the cradle 40, also by securing means 50 such as bolts, screws or rivets distributed along this end.

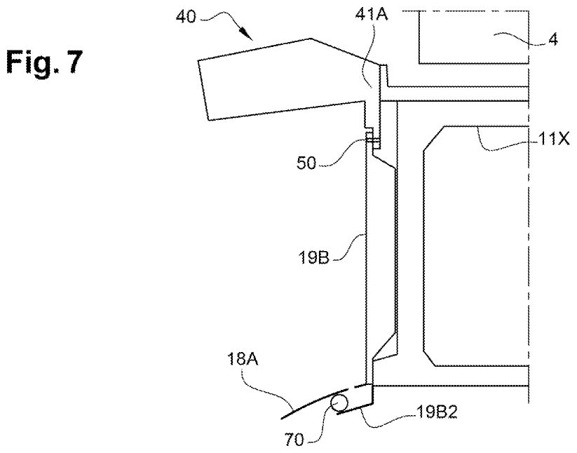

FIG. 7 is a schematic view of such an assembly along a transverse cutting plane passing through one of the aforementioned securing means 50.

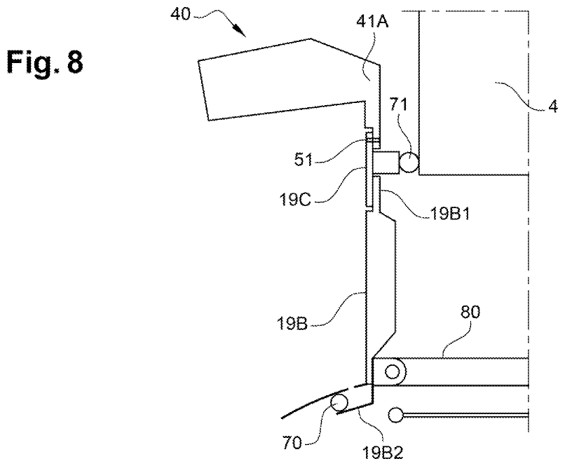

With regard to the panel 19C, a front part of its external end matches a rear part of the primary beam 41A of the cradle 40 (see FIG. 5). The panel 19C is secured to the primary beam 41A by securing means 51 such as bolts, screws or rivets distributed along this front part of the external end of the panel 19C, as shown by FIG. 8, which is a schematic view along a transverse cutting plane passing through one of these securing means 51.

With reference to FIG. 8, the rear end of the panel 19B forms a lip 19B1 coming into abutment on an internal surface of the panel 19C so as to form a continuous smooth join.

With reference to FIGS. 3, 5 and 6, a rear part of the external end of the panel 19C for its part extends along the mast 4 at the rear of the cradle 40. This part of the panel 19C comprises in this example two connecting members 52 and 53.

The connecting members 52 and 53 are configured to connect the panel 19C to the mast 4 in a connection of the sliding pivot type, so as to allow an axial sliding of the panel 19C with respect to the mast 4 and a rotation about an axis that is in this example substantially parallel to the axis A1.

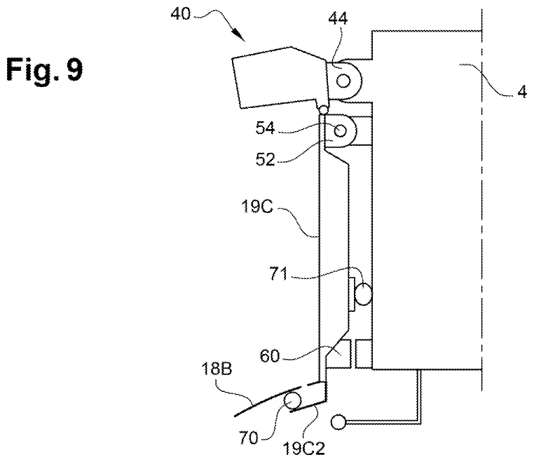

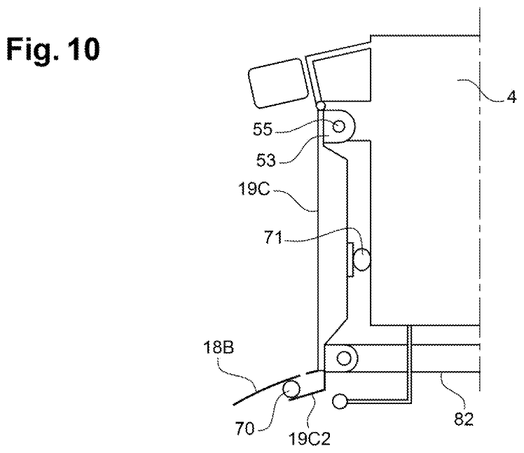

For this purpose, each of the connecting members 52 and 53 forms an orifice through which a shaft 54/55 passes, extending axially and being secured to the mast 4 (see FIGS. 9 and 10).

The panel 19C is thus mounted pendular with respect to the mast 4, which enables it to follow the relative movements of the internal fairing 18, of the cradle 40 and of the mast 4 during movements of the turbojet engine 2 with respect to the mast 4, reducing the deformation stresses.

With reference to FIGS. 6 and 9, the panel 19C is equipped with stops 60 and 61 extending radially in line with an internal surface of the internal end of this panel 19C.

The stop 60 is substantially aligned axially with respect to the connecting members 52 and the stop 61 is substantially aligned axially with respect to the connecting member 53. With reference to FIGS. 7 to 10, the panels 19B and 19C comprise in this example a bottom lip 19B2/19C2 coming facing an internal surface of the fairing 18 and a member of the gasket type 70 is interposed between this internal surface of the fairing 18 and this bottom lip 19B2/19C2 so as to provide a seal between the panels 19A-19C and the internal fairing 18.

In this example, a flame-arrester gasket 71 is moreover interposed between the panels 19B and 19C on either side of the mast 4 (see FIGS. 6 and 8 to 10).

As indicated above, the above applies by analogy to the second part of the lateral fairing 19, which extends on the other side of the mast 4.

With reference to FIG. 6, the propulsion unit 1 comprises in this example three linkages 80, 81 and 82 extending transversely so as to connect in pairs panels of the first and second part of the lateral fairing 19.

In this example, the linkage 80 is articulated firstly on the internal end of the panel 19B of the first part of the lateral fairing 19 and secondly, symmetrically, on the internal end of the panel 19B of the second part of the lateral fairing 19 (see also FIG. 8).

The linkage 81 is articulated firstly on a front part of the internal end of the panel 19C of the first part of the lateral fairing 19 and secondly, symmetrically, on a front part of the internal end of the panel 19C of the second part of the lateral fairing 19.

The linkage 82 is articulated firstly on a rear part of the internal end of the panel 19C of the first part of the lateral fairing 19 and secondly, symmetrically, on a rear part of the internal end of the panel 19C of the second part of the lateral fairing 19 (see also FIG. 10).

The linkages 81 and 82 and the stops 60 and 61 reduce the deflection of the panel 19C when the latter pivots with respect to the mast 4 about the shafts 54 and 55, via the connecting members 52 and 53. The linkage 80 also reduces the deflection of the panel 19B because of such a pivoting of the panel 19C.

To facilitate access with a view to maintenance, the various aforementioned connecting means and members of the lateral fairing 19 can incorporate rapid locking/unlocking members such as bolts (not shown) and/or positioning or centring members such as studs (not shown).

Numerous variants can be made to the above description without departing from the scope of the invention. For example, the propulsion unit 1 may not have an intermediate support structure such as the cradle 40, the means for guiding the movable structure of the reverser 30 being able to be secured to the mast 4.

1. A propulsion unit for an aircraft, comprising a mast, an internal fairing, an external fairing and a lateral fairing, the internal fairing delimiting radially inwards a flow conduit of a secondary flow, the external fairing delimiting the conduit radially outwards, the lateral fairing extending on either side of the mast so as to delimit two circumferential ends of the conduit, the unit also including a thrust reverser that comprises a structure able to move between an advanced position, making it possible to direct the secondary flow towards the rear of the propulsion unit in order to generate a thrust, and a retracted position, making it possible to redirect part of the secondary flow towards the front of the propulsion unit in order to generate a counter-thrust, wherein the lateral fairing comprises a plurality of panels arranged on either side of the mast and each connected to the latter in a connection defining at least one degree of freedom,
and in that the unit comprises a support structure connected to the mast and being intended to be connected to a turbine engine of the propulsion unit so as to be able to follow the movements of the turbine engine with respect to the mast, the movable structure of the reverser being supported by the support structure forming a cradle including two longitudinal members extending respectively on either side of the mast and forming respectively two primary beams that comprise respectively means for guiding the movable structure of the reverser,
and in that said panels are secured to the primary beams by securing means.

2. The propulsion unit according to claim 1, wherein said connection is a pivot, slide or sliding pivot connection.

3. The propulsion unit according to claim 1, comprising one or more linkages and/or cross members extending transversely so as to connect one or more of said panels extending on a first side of the mast to one or more others of said panels extending on a second side of the mast.

4. The propulsion unit according to claim 1, wherein one or more of said panels are configured to crush a sealing member interposed between this or these panels and the internal fairing.

5. The propulsion unit according to claim 1, wherein the movable structure of the reverser comprises diversion cascades.

6. The propulsion unit according to claim 1, wherein the external fairing forms one or more cowls of the movable structure of the reverser.

7. The propulsion unit according to claim 1, comprising a turbine engine.

8. The propulsion unit according to claim 4, wherein the sealing member is a gasket.

9. The propulsion unit according to claim 7, wherein the turbine engine is a turbojet engine.
